(19) United States
(12) Patent Application Publication
(10) Pub. No.: US 2015/0138561 A1
(43) Pub. Date: May 21, 2015

(54) SPECTROSCOPIC MEASUREMENT APPARATUS AND SPECTROSCOPIC MEASUREMENT METHOD

(71) Applicant: Seiko Epson Corporation, Tokyo (JP)

(72) Inventors: Akira SANO, Shiojiri (JP); Tomohiro MAKIGAKI, Matsumoto (JP); Kazunori SAKURAI, Chino (JP)

(21) Appl. No.: 14/546,426

(22) Filed: Nov. 18, 2014

(30) Foreign Application Priority Data
Nov. 19, 2013 (JP) 2013-238593

(51) Int. Cl. G01J 3/45; G01N 21/25

(52) U.S. Cl. CPC G01J 3/45; G01N 21/255; G01N 2201/061
USPC 356/454; 356/451

(57) ABSTRACT

A spectroscopic measurement apparatus includes a wavelength tunable interference filter that selects light of a predetermined wavelength from incident light, allows the selected light to exit, and is capable of changing the wavelength of the light that is allowed to exit, a light dividing element that divides the exiting light having exited out of the wavelength tunable interference filter into a plurality of light fluxes, and a first light receiving device and a second light receiving device that are provided in correspondence with the plurality of divided light fluxes divided by the light dividing element and have sensitivities different from each other.

### BACKGROUND

1. Technical Field

The present invention relates to a spectroscopic measurement apparatus and a spectroscopic measurement method.

2. Related Art

There is a known spectroscopic measurement apparatus of related art in which a light receiving device receives light separated by a spectroscopic device and the amount of the received light is acquired for spectroscopic measurement (see JP-A-2007-127657, for example).

JP-A-2007-127657 describes an imaging apparatus in which a plurality of bandpass filters having bandwidths different from each other as a spectroscopic device are provided and sequentially arranged in a position between an object under measurement and an imaging device and the imaging device receives light fluxes under measurement that pass through the bandpass filters for acquisition of a reflection optical spectrum (optical spectrum) reflected off the object.

In the imaging apparatus described in JP-A-2007-127657, to achieve light exposure within the range of adequate exposure for the imaging device for an object under measurement placed in the imaging apparatus, an exposure period is set for each measurement wavelength. That is, to achieve light exposure for adequate exposure corresponding to the dynamic range of the imaging device, preliminary exposure is performed on the object under measurement for each of the plurality of bandpass filters, and based on results of the preliminary exposure, an exposure period that achieves adequate exposure is acquired for the wavelength corresponding to each of the bandpass filters. Images of the object under measurement are then captured by using the acquired exposure periods. That is, in JP-A-2007-127657, a measurable light amount width is widened by setting an exposure period at each of the measurement wavelengths in correspondence with the dynamic range of the imaging device.

In the imaging apparatus described in JP-A-2007-127657, the exposure periods thus need to be set as described above in order to follow the width of variation in the amount of light under measurement. Further, whenever the object under measurement or the measurement environment changes, the exposure periods need to be set, which is problematic due to long time required to set the exposure periods, an increase in process burden due to the setting, and operation complicated due to the setting.

In view of the fact described above, it is conceivable to solve the problem described above by using a single light receiving device having a wide dynamic range to follow the width of variation in the amount of light under measurement. In general, however, in a spectroscopic measurement apparatus, in which when light under measurement passes through a spectroscopic device, the amount of the light under measurement greatly decreases, use of a high-sensitivity light receiving device is required for high-precision spectroscopic measurement. Since a wide-dynamic-range, high-sensitivity light receiving device is expensive and difficult to manufacture in the first place, it is difficult to widen the measurable light amount width.

### SUMMARY

An advantage of some aspects of the invention is to provide a spectroscopic measurement apparatus and a spectroscopic measurement method capable of readily widening the measurable light amount width.

An aspect of the invention is directed to a spectroscopic measurement apparatus including a spectroscopic device that selects light of a predetermined wavelength from incident light, allows the selected light to exit, and is capable of changing the wavelength of the light that is allowed to exit, a light dividing element that divides the exiting light having exited out of the spectroscopic device into a plurality of light fluxes, and a plurality of light receiving devices that are provided in correspondence with the plurality of divided light fluxes divided by the light dividing element and have sensitivities different from each other.

The spectroscopic measurement apparatus according to the aspect of the invention includes a plurality of light receiving devices having different sensitivities and causes the plurality of light receiving devices to receive the divided light fluxes from the light dividing element to acquire a plurality of detection signals.

In the configuration described above, even when the amount of light under measurement from an object under measurement varies depending on a measurement position, the amount of the exiting light varies in accordance with a measurement wavelength, or any other variation occurs so that the amounts of the divided light fluxes incident on the light receiving devices vary, selecting a detection signal from a high-sensitivity light receiving device when each of the divided light fluxes has a small amount of light whereas selecting a detection signal from a low-sensitivity light receiving device when each of the divided light fluxes has a large amount of light readily allows provision of at least one light receiving device that can be exposed to the light under measurement within the range of light exposure for adequate exposure in correspondence with the width of variation in the amount of light under measurement.

As a result, to widen a measureable light amount width of the light under measurement, it is not necessary to use a wide-dynamic-range, high-sensitivity light receiving device. Further, to precisely set an exposure period in relation to the dynamic range of a light receiving device, it is not necessary to perform preliminary exposure. The measurable light amount width of light under measurement can thus be readily widened.

It is noted that the range of light exposure for adequate exposure is the range of light exposure that allows adequate measurement of a change in grayscale without the light exposure being overexposure or underexposure and is hereinafter also referred to as an adequate exposure range.

Further, since preliminary exposure is not necessarily performed even when an object under measurement or a measurement environment changes, the measurement period can be shortened.

In the spectroscopic measurement apparatus according to the aspect of the invention, it is preferable that each of the light receiving devices outputs a detection signal according to the amount of light to which the light receiving device is exposed, and the spectroscopic measurement apparatus further includes a detection signal acquisition section that acquires the detection signals from the plurality of light receiving devices and a selection section that selects, from the plurality of detection signals acquired with the plurality of light receiving devices, a detection signal so outputted that the detection signal has a signal level corresponding to the range of light exposure for adequate exposure associated with the light receiving device having outputted the selected detection signal.

In the configuration described above, among the plurality of detection signals acquired with the plurality of light receiving devices at a predetermined wavelength, any of the detection signals is so selected that the selected detection signal is detected in such a way that it has a signal level corresponding to the adequate exposure range associated with the light receiving device having outputted the selected detection signal.

As a result, a spectroscopic measurement result based on a detection signal having a signal level corresponding to the adequate exposure range can be acquired, whereby the measurable light amount width of the light under measurement can be widened, and high-precision spectroscopic measurement can be performed.

In the spectroscopic measurement apparatus according to the aspect of the invention, it is preferable that each of the light receiving devices has a plurality of pixels that receive light and outputs the detection signal on a pixel basis, and the selection section selects, from the plurality of detection signals outputted from pixels corresponding to each other in the plurality of light receiving devices, one of the detection signals corresponding to the pixels.

According to the configuration described above, the spectroscopic measurement apparatus receives light of each wavelength from the light receiving devices each having a plurality of pixels and acquires a detection signal on a pixel basis that corresponds to the amount of light to which the pixel is exposed.

In a case where a single light receiving device having a plurality of pixels receives light under measurement and acquires, for example, a spectroscopic image, a high signal level is obtained at a pixel in the image that corresponds to a portion where the reflectance at a predetermined wavelength is high, whereas a low signal level is obtained at a pixel in the image that corresponds to a low reflectance portion. In this case, for example, when the exposure period is so set that light exposure does not exceed saturated light exposure in correspondence with the high reflectance portion, sufficient light exposure cannot undesirably be acquired at a pixel corresponding to the low reflectance portion. Therefore, at the pixel corresponding to the low reflectance portion, the difference between the acquired light exposure and noise components is small, resulting in a high content of noise components in a detection signal, and the spectroscopic image cannot be acquired with high precision.

Conversely, when the exposure period is so set that the amount of light to which the low reflectance portion is exposed falls within the adequate exposure range, a pixel corresponding to the high reflectance portion can be overexposed, and the spectroscopic image cannot be acquired with high precision.

In contrast, since a detection signal is selected on a pixel basis as described above in the aspect of the invention, measurement with the amount of noise components reduced (with SN ratio increased) can be performed even at a pixel corresponding to the low reflectance portion. Further, since a detection signal having a signal level lower than a maximum signal level corresponding to the upper limit of the adequate exposure range is selected on a pixel basis as described above, it is possible to suppress generation of pixels at which an accurate amount of received light cannot be acquired due to overexposure. As a result, high-precision spectroscopic measurement can be performed.

In the spectroscopic measurement apparatus according to the aspect of the invention, it is preferable that the selection section selects, from the plurality of detection signals at the predetermined wavelength, a detection signal that not only corresponds to the range of light exposure for adequate exposure associated with the light receiving device having outputted the selected detection signal but also is so outputted that the detection signal has the greatest signal level.

In the configuration described above, the spectroscopic measurement apparatus selects, from the plurality of detection signals acquired in the same measurement position, a detection signal that does not exceed the maximum signal level but has the greatest signal level.

As a result, among the plurality of light receiving devices having different sensitivities, a detection signal from a light receiving device that has the highest sensitivity and receives light exposure lower than the saturated level can be selected. The amount of noise due to suppression of overexposure and hence underexposure can be more reliably reduced, whereby higher-precision spectroscopic measurement can be performed.

In the spectroscopic measurement apparatus according to the aspect of the invention, it is preferable that the plurality of light receiving devices have resolutions that differ from each other and decrease as sensitivities of the light receiving devices increase, and the selection section selects, from the plurality of detection signals acquired in the same measurement position at the predetermined wavelength, a detection signal that corresponds to the range of light exposure for adequate exposure associated with the light receiving device having outputted the selected detection signal and is outputted from the light receiving device having the highest resolution.

In the configuration described above, the spectroscopic measurement apparatus includes a plurality of light receiving devices that have sensitivities different from each other and receive divided light fluxes based on light under measurement from the same measurement position, and detection signals are outputted from pixels corresponding to each other in the plurality of light receiving devices. Among the detection signals, a detection signal is so selected that the detection signal not only has a signal level corresponding to the adequate exposure range associated with the light receiving device that has outputted the selected detection signal but also is provided from the light receiving device having the highest resolution is selected as a detection signal of the corresponding pixel.

As a result, a detection signal that corresponds to the adequate exposure range and is provided from a higher-resolution light receiving device can be selected as a spectroscopic measurement result, whereby a higher-resolution measurement result can be readily acquired without any change in the exposure period in accordance with the amount of light under measurement and preliminary exposure for setting the exposure period. Further, since preliminary exposure is not required as described above, the measurement period spent to acquire the high-resolution measurement result described above can be shortened.

In the spectroscopic measurement apparatus according to the aspect of the invention, it is preferable that the spectroscopic measurement apparatus further includes a light source and a light source characteristic acquisition section that acquires an output value from the light source at each wavelength, and the selection section selects a detection signal in accordance with the output value from the light source at the wavelength of the light that the spectroscopic device allows to exit.

In the configuration described above, the spectroscopic measurement apparatus acquires a light source characteristic representing an output value, that is, a light amount value from the light source at each wavelength. The light source characteristic allows prediction of the amount of light that exits out of the spectroscopic device and the upper limit of the amount of each of the divided light fluxes at each wavelength. That is, the magnitude of the upper limit of the amount of each of the divided light fluxes at each wavelength corresponds to the magnitude of the output value from the light source. The spectroscopic measurement apparatus therefore selects a detection signal from a low-sensitivity light receiving device when the light source provides a large output value, whereas selecting a detection signal from a high-sensitivity light receiving device when the output value is small. Further, when a plurality of light receiving devices having light reception sensitivities different from each other depending on the wavelength region (infrared region, visible region, and ultraviolet region, for example), a detection signal from a light receiving device having optimum light reception sensitivity at a measurement wavelength is selected. As described above, an appropriate detection signal can be selected in accordance with the characteristic of the light source and the measurement wavelength. Further, since a light source is provided, variation in the amount of light with which an object under measurement is irradiated and hence variation in light under measurement can be suppressed, whereby higher-precision measurement can be performed.

In the spectroscopic measurement apparatus according to the aspect of the invention, it is preferable that the spectroscopic device is a Fabry-Perot filter.

In the configuration described above, using a Fabry-Perot filter as the spectroscopic device allows measurement to be performed at wavelengths under measurement set apart by very narrow intervals, such as 10 nm. The measurement can therefore be performed at a large number of measurement wavelengths (several tens of measurement wavelengths, for example) within a wavelength range under measurement as compared with a case where the controllable interval between wavelengths under measurement is large. In the latter case, performing preliminary exposure described above on an object under measurement at a plurality of measurement wavelengths or performing preliminary exposure whenever an object under measurement is changed increases the period spent for the preliminary exposure as compared with a case where the measurement is performed at about several wavelengths. Using a Fabry-Perot filter in a configuration that does not require preliminary exposure as in the aspect of the invention can therefore further shorten the measurement period.

Another aspect of the invention is directed to a spectroscopic measurement method in a spectroscopic measurement apparatus including a spectroscopic device that selects light of a predetermined wavelength from incident light, allows the selected light to exit, and is capable of changing the wavelength of the light that is allowed to exit, a light dividing element that divides the exiting light having exited out of the spectroscopic device into a plurality of light fluxes, and a plurality of light receiving devices that are provided in correspondence with the plurality of divided light fluxes divided by the light dividing element and have sensitivities different from each other. The method includes allowing the spectroscopic measurement apparatus to sequentially switch the wavelength by using the spectroscopic device and acquire detection signals from the plurality of light receiving devices at the wavelength, and select, from the plurality of detection signals acquired with the plurality of light receiving devices, a detection signal so outputted that the detection signal has a signal level corresponding to the range of light exposure for adequate exposure associated with the light receiving device having outputted the selected detection signal.

According to the aspect of the invention, a plurality of detection signals corresponding to the plurality of light receiving devices having different sensitivities are acquired, and a detection signal is so selected from the plurality of detection signals that the selected detection signal is detected in such a way that it has a signal level corresponding to the adequate exposure range associated with the light receiving device having detected the selected detection signal.

As a result, the measurable light amount width (dynamic range) of light under measurement can be widened, as in the spectroscopic measurement apparatus according to the aspect of the invention described above. The measurable light amount width of light under measurement can thus be readily widened without use of a wide-dynamic-range, high-sensitivity light receiving device or precise setting of the exposure period in relation to the dynamic range of a light receiving device.

Further, even when an object under measurement or a measurement environment changes, preliminary exposure is not necessarily performed, whereby the measurement period can be shortened.

Moreover, a detection signal having a signal level corresponding to the adequate exposure range can thus be a spectroscopic measurement result in each measurement position at each measurement wavelength, whereby the dynamic range described above can be widened and high-precision spectroscopic measurement can be performed.

### BRIEF DESCRIPTION OF THE DRAWINGS

The invention will be described with reference to the accompanying drawings, wherein like numbers reference like elements.

FIG. 1 is a block diagram showing a schematic configuration of a spectroscopic measurement apparatus according to a first embodiment.

FIG. 2 is a plan view showing a schematic configuration of a wavelength tunable interference filter in the embodiment.

FIG. 3 is a cross-sectional view showing a schematic configuration of the wavelength tunable interference filter in the embodiment.

FIGS. 4A and 4B show graphs illustrating an example of the relationship between exposure periods and detection signals.

FIG. 5 is a flowchart of a spectroscopic measurement process in the embodiment.

FIG. 6 shows graphs illustrating an example of the relationship between a measurement wavelength and the detection signals.

FIGS. 7A and 7B show schematic configurations of light receiving devices provided in a spectroscopic measurement apparatus in a second embodiment.

FIG. 8 shows graphs illustrating an example of the relationship between a measurement wavelength and detection signals.

FIG. 9 shows an example of a spectroscopic image.

FIG. 10 is a block diagram showing a schematic configuration of a spectroscopic measurement apparatus in a third embodiment.

### DESCRIPTION OF EXEMPLARY EMBODIMENTS

### First Embodiment

A first embodiment according to the invention will be described below with reference to the drawings.

### Configuration of Spectroscopic Measurement Apparatus

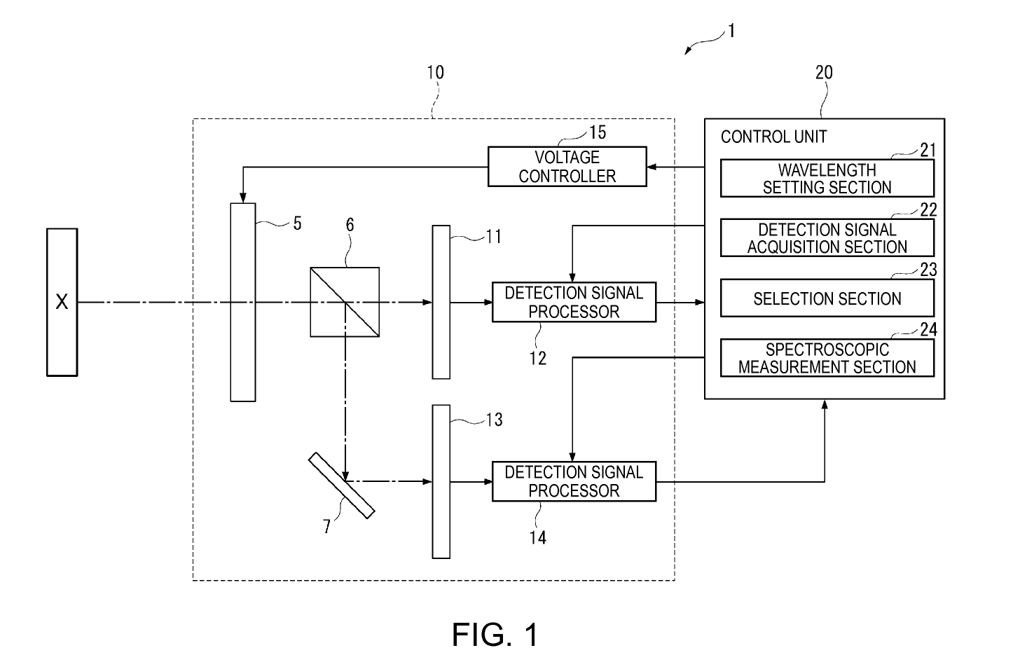

FIG. 1 is a block diagram showing a schematic configuration of a spectroscopic measurement apparatus according to the embodiment of the invention.

A spectroscopic measurement apparatus 1 is an apparatus that analyzes the optical intensity of light under measurement reflected off an object X under measurement at each wavelength for measurement of an optical spectrum. In the present embodiment, the light under measurement reflected off the object X under measurement is measured by way of example. Instead, when the object X under measurement is a light emitting object, such as a liquid crystal panel, light emitted from the light emitting object may be the light under measurement.

The spectroscopic measurement apparatus 1 includes an optical module 10 and a control unit 20, which controls the optical module 10 and processes a signal outputted from the optical module 10, as shown in FIG. 1.

### Configuration of Optical Module

The optical module 10 includes a wavelength tunable interference filter 5, a light dividing element 6, a mirror 7, a first light receiving device 11, a second light receiving device 13, detection signal processors 12 and 14 provided in correspondence with the light receiving devices 11 and 13 respectively, and a voltage controller 15.

In the optical module 10, the light under measurement reflected off the object X under measurement is guided via an incident light optical system (not shown) to the wavelength tunable interference filter 5, and light having passed through the wavelength tunable interference filter 5 is divided into two divided light fluxes having substantially the same amount of light with one of the divided light fluxes received with the first light receiving device and the other divided light flux received with the second light receiving device 13. A detection signal outputted from the first light receiving device 11 is inputted to the control unit 20 via the detection signal processor 12, and a detection signal outputted from the second light receiving device 13 is inputted to the control unit 20 via the detection signal processor 14.

### Configuration of Wavelength Tunable Interference Filter

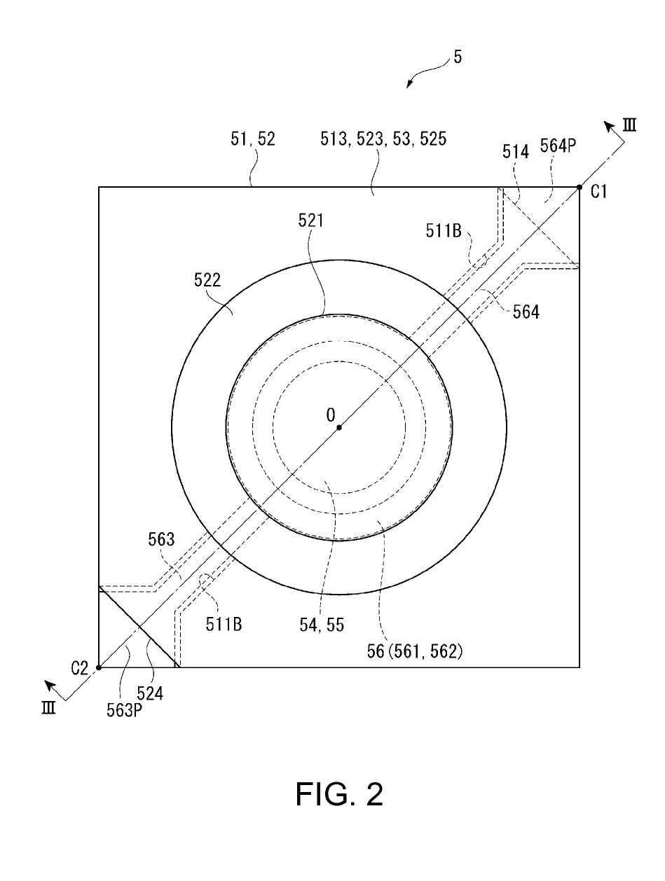

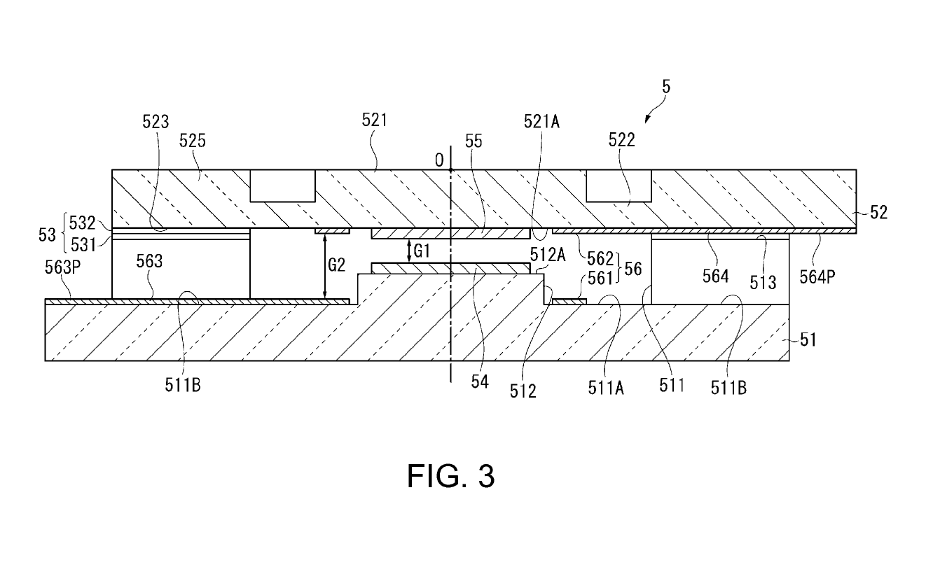

FIG. 2 is a plan view showing a schematic configuration of the wavelength tunable interference filter. FIG. 3 is a cross-sectional view of the wavelength tunable interference filter taken along the line III-III in FIG. 2.

The wavelength tunable interference filter 5 is a wavelength tunable Fabry-Perot etalon. The wavelength tunable interference filter 5 is, for example, a rectangular plate-shaped optical member and includes a fixed substrate 51 and a movable substrate 52. Each of the fixed substrate 51 and the movable substrate 52 is made, for example, of soda glass, crystalline glass, fused silica glass, lead glass, potassium glass, borosilicate glass, no-alkali glass, or any of a variety of other glass materials, or quartz. A first bonding portion 513 of the fixed substrate 51 and a second bonding portion 523 of the movable substrate are bonded to each other via a bonding film 53 (first bonding film 531 and second bonding film 532) formed, for example, of a plasma polymerization film primarily made, for example, of siloxane so that the fixed substrate 51 and the movable substrate 52 are integrated with each other.

A fixed reflection film 54 is provided on the fixed substrate 51, and a movable reflection film 55 is provided on the movable substrate 52. The fixed reflection film 54 and the movable reflection film 55 are so disposed that they face each other via a gap G1. The wavelength tunable interference filter 5 is provided with an electrostatic actuator 56, which is used to adjust (change) the dimension of the gap G1.

In a plan view or FIG. 2 in which the wavelength tunable interference filter 5 is viewed in the substrate thickness direction of the fixed substrate 51 (movable substrate 52) (hereinafter referred to as filter plan view), a plan-view center point O of the fixed substrate 51 and the movable substrate 52 coincides with not only the center points of the fixed reflection film 54 and the movable reflection film 55 but also the center point of a movable portion 521, which will be described later.

### Configuration of Fixed Substrate

The fixed substrate 51 has an electrode placement groove 511 and a reflection film attachment portion 512 formed therein in an etching process. The fixed substrate 51 is formed to be thicker than the movable substrate 52 and is not therefore bent by an electrostatic attractive force produced when a voltage is applied between a fixed electrode 561 and a movable electrode 562 or internal stress induced in the fixed electrode 561 by the voltage application.

Further, a cutout 514 is formed at a vertex C1 of the fixed substrate 51 and exposes a movable electrode pad 564P, which will be described later and faces the fixed substrate 51 of the wavelength tunable interference filter 5.

The electrode placement groove 511 is so formed that it has an annular shape around the plan-view center point O of the fixed substrate 51 in the filter plan view. The reflection film attachment portion 512 is so formed that it protrudes from a central portion of the electrode placement groove 511 in the plan view described above toward the movable substrate 52. A groove bottom surface of the electrode placement groove 511 forms an electrode attachment surface 511A, on which the fixed electrode 561 is disposed. Further, the front end surface of the thus protruding reflection film attachment portion 512 forms a reflection film attachment surface 512A.

Further, electrode drawing grooves 511B, which extend from the electrode placement groove 511 toward the vertices C1 and C2 at the outer circumferential edge of the fixed substrate 51, are provided in the fixed substrate 51.

The fixed electrode 561, which forms the electrostatic actuator 56, is disposed on the electrode attachment surface 511A of the electrode placement groove 511. More specifically, the fixed electrode 561 is disposed on the electrode attachment surface 511A in a region facing the movable electrode 562 on the movable portion 521, which will be described later. An insulating film for ensuring insulation between the fixed electrode 561 and the movable electrode 562 may be layered on the fixed electrode 561.

A fixed drawn electrode 563 is provided on the fixed substrate 51 and extends from the outer circumferential edge of the fixed electrode 561 toward the vertex C2. A front end portion of the thus extending fixed drawn electrode 563 (portion located at vertex C2 of fixed substrate 51) forms a fixed electrode pad 563P, which is connected to the voltage controller 15.

In the present embodiment, the single fixed electrode 561 is provided on the electrode attachment surface 511A, but a configuration in which two concentric electrodes formed around the plan-view center point O are provided on the electrode attachment surface 511A (dual electrode configuration) or any other configuration may instead be employed.

The reflection film attachment portion 512 is coaxial with the electrode placement groove 511, has a substantially cylindrical shape having a diameter smaller than that of the electrode placement groove 511, and has the reflection film attachment surface 512A facing the movable substrate 52, as described above.

The fixed reflection film 54 is disposed on the reflection film attachment portion 512, as shown in FIG. 3. The fixed reflection film 54 can be formed, for example, of a metal film made, for example, of Ag or an alloy film made, for example, of an Ag alloy. The fixed reflection film 54 may instead be formed of a dielectric multilayer film, for example, having a high refractive layer made of TiO₂ and a low refractive layer made of SiO₂. The fixed reflection film 54 may still instead be a reflection film formed of a metal film (or alloy film) layered on a dielectric multilayer film, a reflection film formed of a dielectric multilayer film layered on a metal film (or alloy film), or a reflection film that is a laminate of a single-layer refractive layer (made, for example, of TiO₂ or SiO₂) and a metal film (or alloy film).

An antireflection film may be formed on a light incident surface of the fixed substrate 51 (surface on which fixed reflection film 54 is not provided) in a position corresponding to the fixed reflection film 54. The antireflection film can be formed by alternately layering a low refractive index film and a high refractive index film on each other, and the thus formed antireflection film decreases visible light reflectance of the surface of the fixed substrate 51 whereas increasing visible light transmittance thereof.

Part of the surface of the fixed substrate 51 that faces the movable substrate 52, specifically, the surface where the electrode placement groove 511, the reflection film attachment portion 512, or the electrode drawing grooves 511B are not formed in the etching process forms the first bonding portion 513. A first bonding film 531 is provided on the first bonding portion 513 and bonded to a second bonding film 532 provided on the movable substrate 52, whereby the fixed substrate 51 and the movable substrate 52 are bonded to each other as described above.

### Configuration of Movable Substrate

The movable substrate 52 has the movable portion 521, which has a circular shape around the plan-view center point O, a holding portion 522, which is coaxial with the movable portion 521 and holds the movable portion 521, and a substrate outer circumferential portion 525, which is provided in a region outside the holding portion 522, in the filter plan view of FIG. 2.

Further, the movable substrate 52 has a cutout 524 formed in correspondence with the vertex C2, and the cutout 524 exposes the fixed electrode pad 563P when the wavelength tunable interference filter 5 is viewed from the side where the movable substrate 52 is present, as shown in FIG. 2.

The movable portion 521 is formed to be thicker than the holding portion 522. In the present embodiment, for example, the movable portion 521 is formed to be as thick as the movable substrate 52. The movable portion 521 is so formed that it has a diameter greater than at least the diameter of the outer circumferential edge of the reflection film attachment surface 512A in the filter plan view. The movable electrode 562 and the movable reflection film 55 are disposed on the movable portion 521.

An antireflection film may be formed on the surface of the movable portion 521 that faces away from the fixed substrate 51, as in the case of the fixed substrate 51. The antireflection film can be formed by alternately layering a low refractive index film and a high refractive index film on each other, and the thus formed antireflection film can decrease visible light reflectance of the surface of the movable substrate 52 whereas increasing visible light transmittance thereof.

The movable electrode 562 faces the fixed electrode 561 via a gap G2 and is so formed that it has an annular shape that conforms to the shape of the fixed electrode 561. The movable electrode 562 along with the fixed electrode 561 forms the electrostatic actuator 56. A movable drawn electrode 564 is provided on the movable substrate 52 and extends from the outer circumferential edge of the movable electrode 562 toward a vertex C1 of the movable substrate 52. A front end portion of the thus extending movable drawn electrode 564 (portion located at vertex C1 of movable substrate 52) forms the movable electrode pad 564P, which is connected to the voltage controller 15.

The movable reflection film 55 is so disposed on a central portion of a movable surface 521A of the movable portion 521 that the movable reflection film 55 faces the fixed reflection film 54 via the gap G1. The movable reflection film 55 has the same configuration as that of the fixed reflection film 54 described above.

In the present embodiment, the dimension of the gap G2 is greater than the dimension of the gap G1 as described above by way of example, but the dimensions of the gaps are not necessarily set in this way. For example, when light under measurement is infrared light or far infrared light, the dimension of the gap G1 may be greater than the dimension of the gap G2 depending on the wavelength range of the light under measurement.

The holding portion 522 is a diaphragm that surrounds the movable portion 521 and is formed to be thinner than the movable portion 521. The thus configured holding portion 522 is more readily bent than the movable portion 521 and can therefore displace the movable portion 521 toward the fixed substrate 51 under a small magnitude of electrostatic attractive force. Since the movable portion 521 is thicker and therefore more rigid than the holding portion 522, the movable portion 521 is not deformed when the holding portion 522 is attracted toward the fixed substrate 51 under an electrostatic attractive force. The movable reflection film 55 disposed on the movable portion 521 will therefore not be bent, whereby the fixed reflection film 54 and the movable reflection film 55 can be consistently maintained parallel to each other.

In the present embodiment, the diaphragm-shaped holding portion 522 is presented by way of example, but the holding portion 522 is not necessarily formed of a diaphragm. For example, beam-shaped holding portions disposed at equal angular intervals may be provided around the plan-view center point O.

The substrate outer circumferential portion 525 is disposed in a region outside the holding portion 522 in the filter plan view, as described above. The second bonding portion 523, which faces the first bonding portion 513, is provided on the surface of the substrate outer circumferential portion 525 that faces the fixed substrate 51. The second bonding film 532 is provided on the second bonding portion 523 and bonded to the first bonding film 53, whereby the fixed substrate 51 and the movable substrate 52 are bonded to each other as described above.

### Configuration of Light Dividing Element and Mirror

Referring back to FIG. 1, other components of the optical module 10 will next be described.

The light dividing element 6 is a beam splitter that divides the light having passed through the wavelength tunable interference filter 5 into two divided light fluxes having substantially the same amount of light. The light dividing element 6 may instead be a polarization beam splitter that receives, for example, s-polarized light and p-polarized light, transmits one of the polarized light components, and reflects the other polarized light component. The light dividing element 6 may still instead be, for example, a half-silvered mirror that transmits part of light incident thereon and reflects the other part of the incident light. The light dividing element 6 is disposed in the optical path of the light that passes through the wavelength tunable interference filter 5 and travels toward the first light receiving device 11. The divided light that passes through the light dividing element 6 is received with the first light receiving device 11.

The mirror 7 directs the divided light that is reflected off a reflection surface of the light dividing element 6 toward the second light receiving device 13.

### Configurations of Light Receiving Devices, Detection Signal Processors, and Voltage Controller

The first light receiving device 11, specifically, a plurality of pixels therein receive (detect) one of the divided light fluxes having passed through the wavelength tunable interference filter 5 and having been divided by the light dividing element 6 and output detection signals (first detection signals) based on the amounts of received light on a pixel basis to the detection signal processor 12. That is, the first light receiving device 11, when exposed to light, outputs detection signals according to the amounts of exposure to the light on a pixel basis.

Similarly, the second light receiving device 13 receives the other one of the divided light fluxes having passed through the wavelength tunable interference filter 5 and having been divided by the light dividing element 6 on a pixel basis and outputs detection signals (second detection signals) based on the amounts of received light on a pixel basis to the detection signal processor 14.

The light receiving device 11 and the second light receiving device 13 have sensitivities different from each other, and the first light receiving device 11 is less sensitive than the second light receiving device 13. Since the light receiving devices 11 and 13 have sensitivities relatively different from each other, the first light receiving device 11 and the second light receiving device 13 are also hereinafter called a low-sensitivity light receiving device and a high-sensitivity light receiving device, respectively.

In the spectroscopic measurement apparatus 1, before spectroscopic measurement is made, exposure periods for which the light receiving devices 11 and 13 are exposed are preferably so set that at least one of the light receiving devices 11 and 13 is exposed to light within an adequate exposure range, that is, the exposure periods are preferably set in accordance with the amounts of the divided light fluxes in an illumination environment under which an actual spectroscopic measurement process is carried out. The amounts of the divided light fluxes, each of which is part of the light having exited out of the wavelength tunable interference filter 5, corresponds to the amount of light under measurement, and the amount of light under measurement corresponds to the amount of illumination light. Therefore, when the illumination environment changes, the amounts of the divided light fluxes change accordingly, and setting the exposure periods in accordance with the illumination environment allows spectroscopic measurement to be performed with higher precision. The exposure periods may instead be set in advance.

Each of the light receiving devices 11 and 13 has a predetermined light amount width as a measureable light amount width of light under measurement in accordance with an adequate exposure range of the light receiving device. The predetermined light amount widths described above of the light receiving devices 11 and 13 at least partially overlap with each other. As a result, in the spectroscopic measurement apparatus 1, the light receiving devices 11 and 13 can appropriately detect the amount of light under measurement within a single continuous predetermined light amount width.

More specifically, the adequate exposure range and the exposure period of each of the light receiving devices 11 and 13 are so set that the amount of light under measurement corresponding to a maximum of the adequate exposure range of the high-sensitivity second light receiving device 13 is greater than or equal to the amount of light under measurement corresponding to a minimum of the adequate exposure range of the low-sensitivity first light receiving device 11. As a result, one of the first light receiving device 11 and the second light receiving device 13, when exposed to the light under measurement over the exposure period, outputs a detection signal corresponding to the adequate exposure range.

The exposure periods are set by performing spectroscopic measurement on a high reflectance reference object having reflectance greater than or equal to a predetermined first specified value (99%, for example) at each wavelength within a predetermined wavelength range and a low reflectance reference object having reflectance smaller than or equal to a predetermined second specified value (1%, for example) at each wavelength within the predetermined wavelength range. For example, when the spectroscopic measurement is performed in the visible light range, a white reference plate can, for example, be used as the high reflectance reference object, and a black reference plate can, for example, be used as the low reflectance reference object.

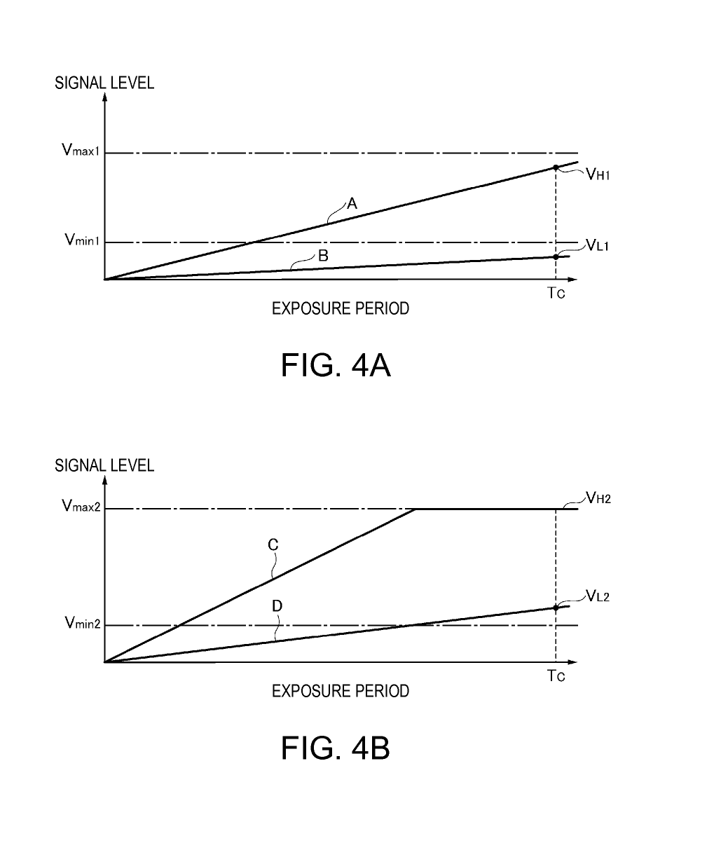

FIGS. 4A and 4B show graphs diagrammatically illustrating an example of the relationship between the exposure period and the signal level (pixel output in voltage) of the detection signal from a single pixel in each of the light receiving devices 11 and 13. FIG. 4A shows the relationship described above associated with the low-sensitivity first light receiving device 11, and FIG. 4B shows the relationship described above associated with the high-sensitivity second light receiving device 13. A detection signal A in FIG. 4A and a detection signal C in FIG. 4B are results of measurement made on the white reference plate, and a detection signal B in FIG. 4A and a detection signal D in FIG. 4B are results of measurement made on the black reference plate.

In a case where an object under measurement has high reflectance, the signal level of each of the detection signals increases as the exposure period increases at a higher rate than in a case where the object under measurement has low reflectance, as shown in FIGS. 4A and 4B. Conversely, in a case where the object under measurement has low reflectance, the signal level of each of the detection signals increases as the exposure period increases at a lower rate than in a case where the object under measurement has high reflectance. Too long an exposure period may cause the level of the detection signal from the low-sensitivity first light receiving device 11 to reach the upper limit of the adequate exposure range of the first light receiving device 11, undesirably resulting in inadequate acquisition of the detection signal associated with a high-reflectance object under measurement in some cases. On the other hand, too short an exposure period may undesirably cause the level of the detection signal from the second light receiving device 13 not to reach the lower limit of the adequate exposure range of the second light receiving device 13 in some cases. In the latter case, the detection signal also has a low signal level, resulting in an increase in the proportion of noise components due, for example, to external light and a decrease in the SN ratio.

Therefore, in the present embodiment, the exposure periods are at least so set that the light receiving devices can be exposed to light under measurement within the adequate exposure range of the low-sensitivity first light receiving device 11 in a case where the amounts of the divided light fluxes are relatively large and within the adequate exposure range of the high-sensitivity second light receiving device 13 in a case where the amounts of the divided light fluxes are relatively small.

Specifically, for the low-sensitivity first light receiving device 11, an exposure period T_{c} is so set that when light reflected off the white reference plate is measured with the first light receiving device 11, a signal level V_{H1} of the detection signal A outputted from one pixel of the first light receiving device 11 at each wavelength is lower than a maximum signal level Vₘₐₓ₁ corresponding to saturated light exposure associated with the first light receiving device 11 but higher than or equal to a lower limit signal level Vₘᵢₙ₁ corresponding to the lower limit of the adequate exposure associated with the first light receiving device 11, as shown in FIG. 4A. It is noted that in a case where the first light receiving device 11 receives light reflected off the black reference plate, a signal level V_{L1} of the detection signal from the first light receiving device 11 is lower than the signal level V_{H1} at the point after the exposure period T_{c} elapses.

On the other hand, for the high-sensitivity second light receiving device 13, the exposure period T_{c} is so set that when light reflected off the black reference plate is received with the second light receiving device 13 and after the exposure period T_{c} elapses, the signal level of the detection signal D outputted from one pixel of the second light receiving device 13 at each wavelength is lower than a maximum signal level Vₘₐₓ₂ corresponding to saturated light exposure associated with the second light receiving device 13 but higher than or equal to a lower limit signal level Vₘₐₓ₂ corresponding to the lower limit of the adequate exposure associated with the second light receiving device 13, as shown in FIG. 4B. It is noted that in a case where the second light receiving device 13 measures light reflected off the white reference plate, the signal level of the detection signal from the second light receiving device 13 reaches the maximum signal level Vₘₐₓ₂ thereof at the point after the exposure period T_{c} elapses.

As described above, in the present embodiment, the exposure period T_{c} for the first light receiving device 11 is so set that the detection signal from the first light receiving device 11 has a signal level lower than the maximum signal level Vₘₐₓ₁ thereof when the white reference plate is measured and the detection signal from the second light receiving device 13 has a signal level greater than or equal to the lower limit signal level Vₘₐₓ₂ when the black reference plate is measured.

The exposure periods described above primarily depend on the illuminance of external light and the illumination light. Therefore, in the spectroscopic measurement apparatus 1, the exposure periods may be set based on results of spectroscopic measurement performed on predetermined reference objects (white reference plate and black reference plate, for example) in an illumination environment under which the spectroscopic measurement is actually performed. A table that relates the illuminance of the illumination light to each of the exposure periods described above may be stored in a memory in advance, and the exposure periods may be set based on the illuminance of the illumination light and the table. Information on the set exposure periods is stored in the memory.

The detection signal processors 12 and 14 amplify the detection signals (analog signals) inputted thereto and then convert the analog detection signals into digital signals and output the digital signals to the control unit 20. Each of the detection signal processors 12 and 14 is formed, for example, of an amplifier that amplifies the corresponding detection signal and an A/D converter that converts an analog signal into a digital signal.

The voltage controller 15 applies a drive voltage to the electrostatic actuator 56 in the wavelength tunable interference filter 5 under the control of the control unit 20. As a result, an electrostatic attractive force is produced in the space between the fixed electrode 561 and the movable electrode 562 of the electrostatic actuator 56, and the electrostatic attractive force displaces the movable portion 521 toward the fixed substrate 51.

### Configuration of Control Unit

The control unit 20 in the spectroscopic measurement apparatus 1 will next be described.

The control unit 20 is formed of a combination of a CPU, a memory, and other components and controls the overall action of the spectroscopic measurement apparatus 1. The control unit 20 includes a wavelength setting section 21, a detection signal acquisition section 22, a selection section 23, and a spectroscopic measurement section 24, as shown in FIG. 1. A memory in the control unit 20 stores V-λ data representing the wavelength of light allowed to pass through the wavelength tunable interference filter 5 versus a drive voltage applied to the electrostatic actuator 56 in correspondence with the wavelength.

The wavelength setting section 21 sets a target wavelength of light to be extracted through the wavelength tunable interference filter 5 and outputs an instruction signal to the voltage controller 15 to cause it to apply a drive voltage corresponding to the set target wavelength based on the V-λ data to the electrostatic actuator 56.

The detection signal acquisition section 22 acquires detection signals from the light receiving devices 11 and 13 at the timings when the exposure periods T_{c} elapse, that is, acquires detection signals corresponding to the light fluxes into which the light of the target wavelength having passed through the wavelength tunable interference filter 5 is divided.

Among detection signals corresponding to each of the pixels in the light receiving devices 11 and 13, specifically, detection signals lower than the maximum signal levels Vₘₐₓ corresponding to the saturated light exposure values associated with the light receiving devices 11 and 13 (first detection signal and second detection signal), the selection section 23 selects one of the detection signals that has higher a signal level on a pixel basis.

The spectroscopic measurement section 24 measures a spectral characteristic of the light under measurement based on the amounts of light acquired by the detection signal acquisition section 22.

### Spectroscopic Measurement Process

A spectroscopic measurement process carried out by the spectroscopic measurement apparatus 1 described above will next be described below with reference to the drawings.

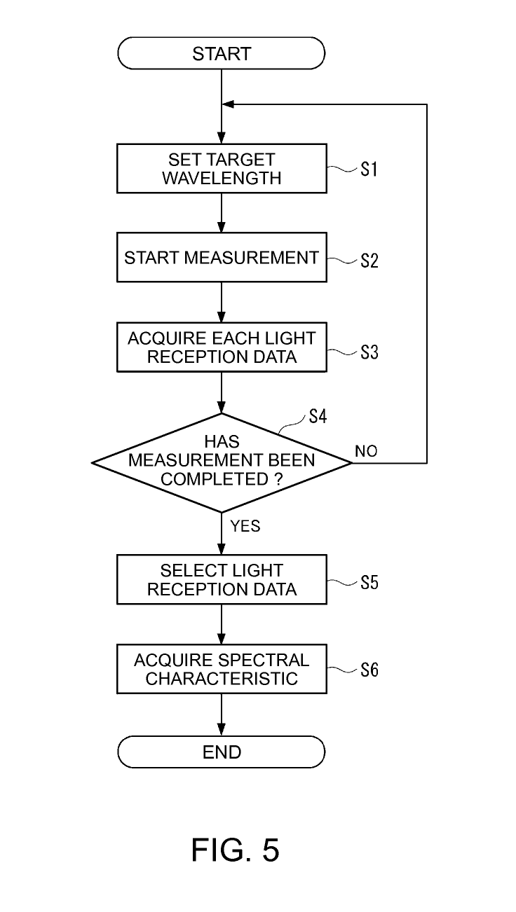

FIG. 5 is a flowchart of the spectroscopic measurement process carried out by the spectroscopic measurement apparatus 1.

In the spectroscopic measurement process, the wavelength setting section 21, when it receives a measurement start instruction, reads a drive voltage corresponding to a predetermined measurement wavelength within a wavelength range under measurement from the V-λ data stored in the memory and outputs an instruction signal to the voltage controller 15 to cause it to apply the drive voltage to the electrostatic actuator 56, as shown in FIG. 5. As a result, the drive voltage is applied to the electrostatic actuator 56, and the gap G1 is set at a dimension corresponding to the measurement wavelength (step S1).

After the gap G1 is set at the dimension corresponding to the measurement wavelength in step S1, the wavelength tunable interference filter 5 transmits light of the measurement wavelength, and light fluxes divided by the light dividing element 6 are incident on the light receiving devices 11 and 13. At this point, the detection signal acquisition section 22 starts detection of light under measurement with the light receiving devices 11 and 13 in response to an instruction signal that instructs start of detection of the light under measurement (step S2).

When the exposure periods T_{c} have elapsed after the start of the spectroscopic measurement, the detection signal acquisition section 22 acquires a detection signal at each of the pixels in the first light receiving device 11 (first detection signal) and a detection signal at each of the pixels in the second light receiving device 13 (second detection signal). The detection signal acquisition section 22 stores first light reception data that relates the following data to each other in the memory: the first detection signal acquired at each of the pixels; the position of the pixel (address data) ; and the wavelength of the light having exited out of the wavelength tunable interference filter 5 (measurement wavelength). Similarly, the detection signal acquisition section 22 stores second light reception data that relates the following data to each other in the memory: the second detection signal acquired at each of the pixels; the position of the pixel; and the measurement wavelength (step S3).

The control unit 20 then evaluates whether or not the amounts of light at all measurement wavelengths in the wavelength range under measurement have been acquired (step S4).

In step S4, when there remains a measurement wavelength at which the spectroscopic measurement has not been performed (when evaluation result is “No”), the control returns to step 51, where the measurement wavelength is changed and the spectroscopic measurement is resumed. As described above, sequentially switching a wavelength in the wavelength range under measurement to another for the spectroscopic measurement allows acquisition of the first light reception data and the second light reception data at each of the wavelengths.

The measurement wavelengths may, for example, be wavelengths set in advance by a measurement operator or wavelengths set apart from each other at predetermined wavelength intervals (10-nm intervals, for example).

When the evaluation result instep S4 shows that the spectroscopic measurement has been performed at all measurement wavelengths, the selection section 23 selects one of the first light reception data and the second light reception data as a result of the measurement at each pixel at each wavelength (step S5). The selection section 23 selects one of the first detection signal and the second detection signal that has a signal level corresponding to the adequate exposure range at each pixel at each wavelength. In the present embodiment, in particular, the selection section 23 selects light reception data containing one of the two detection signals, the first detection signal from the low-sensitivity first light receiving device 11 and the second detection signal from the high-sensitivity second light receiving device 13, specifically, the detection signal having a higher signal level but lower than the maximum signal level corresponding to the saturated light exposure associated with the light receiving device having outputted the selected detection signal.

In other words, in a spectroscopic image acquired with the second light receiving device 13, which outputs a detection signal having a greater signal level, a pixel showing a greater amount of light than the amount of light corresponding to the maximum signal level (abnormal light amount pixel) is detected. Thereafter, the amount of light at a pixel that forms a spectroscopic image acquired with the first light receiving device 11 and corresponds to the abnormal light amount pixel described above is detected, and the amount of light at the abnormal light amount pixel is replaced with a corrected amount of light obtained by correcting the detected amount of light in accordance with the sensitivity ratio between the two light receiving devices.

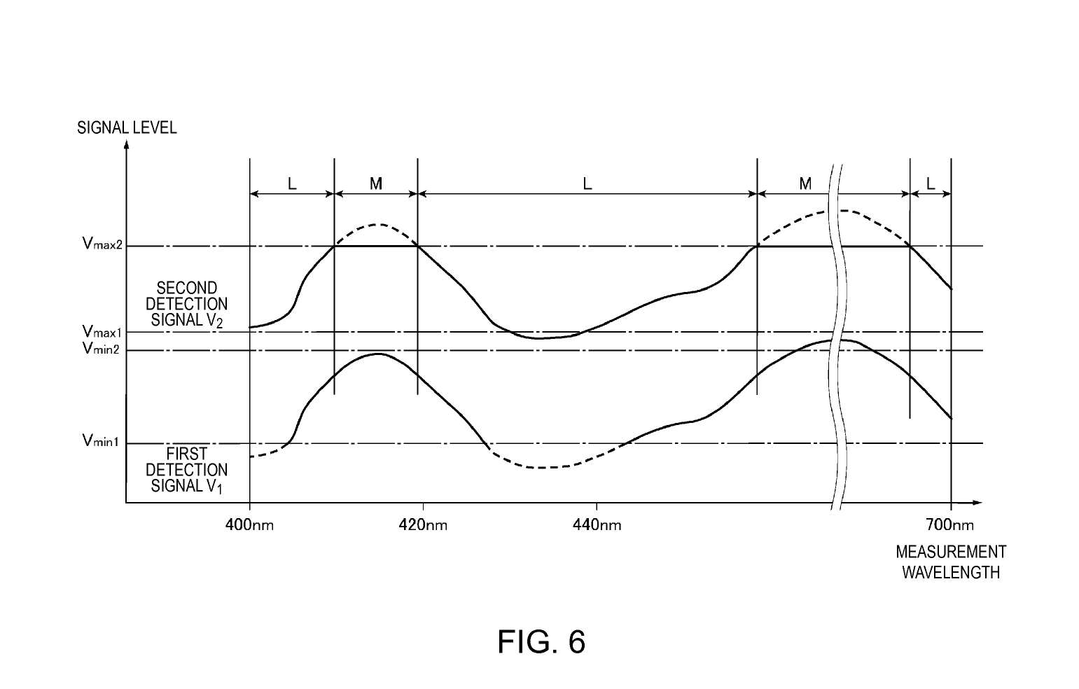

FIG. 6 shows graphs illustrating an example of the relationship between the measurement wavelength and the signal level of each of the detection signals at one predetermined pixel among the plurality of pixels that form the first light receiving device 11. As shown in FIG. 6, a first detection signal V₁ is provided from the low-sensitivity first light receiving device 11 and has a signal level lower than the signal level of a second detection signal V₂ from the high-sensitivity second light receiving device 13. Further, the first detection signal V₁, which does not exceed the saturated light exposure and corresponds to the exposure period T_{c} as described above, has a signal level lower than the maximum signal level Vₘₐₓ₁ at each wavelength within the wavelength range under measurement. The second detection signal V₂, which is not lower than the lower limit of the adequate exposure range and corresponds to the exposure period T_{c} as described above, has a signal level higher than or equal to the lower limit signal level Vₘᵢₙ₂.

When the second detection signal V₂ from the high-sensitivity second light receiving device 13 has a signal level lower than the maximum signal level Vₘₐₓ₂, that is, in wavelength ranges labeled with segments L shown in FIG. 6, the second light reception data corresponding to the second detection signal V₂, which represents greater light exposure, is selected.

When the second detection signal V₂ reaches the maximum signal level Vₘₐₓ₂, that is, in wavelength ranges labeled with segments M shown in FIG. 6, the first light reception data corresponding to the first detection signal V₁, which has a signal level lower than the maximum signal level Vₘₐₓ₁ associated with the first light receiving device 11, is selected.

The selection section 23 selects light reception data at each pixel at each wavelength, as described above. As a result, light reception data acquired under light exposure within one of the adequate exposure ranges is selected at each pixel at each wavelength.

The spectroscopic measurement section 24 then uses the selected light reception data to acquire an optical spectrum (step S6).

In the present embodiment, the first detection signal V₁ and the second detection signal V₂ are detected with light receiving devices having different sensitivities and hence have signal levels different from each other and result from light exposure values different from each other. It is therefore necessary to correct the detection signals in accordance with sensitivities of the light receiving devices. It is noted that when the exposure periods over which the detection signals are acquired are equal to each other, the signal levels increase in proportion to the sensitivities.

For example, the spectroscopic measurement section 24 multiplies the signal level of the first detection signal V₁ by a correction coefficient (sensitivity of second light receiving device/sensitivity of first light receiving device, for example) (see signal levels indicated by broken lines in segments M in FIG. 6). On the other hand, the signal level of the second detection signal V₂ is left unchanged and corresponds directly to the amount of light. The amounts of light corresponding to the first detection signal in the segments M can therefore be calculated as the amounts of light corresponding to the second detection signal and handled with those in the segments L. It is noted that a value corresponding to the amount of light calculated as described above may further be multiplied by a predetermined gain or otherwise processed.

The spectroscopic measurement section 24 then uses the amount of light calculated at each wavelength to calculate an optical spectrum under measurement.

The spectroscopic measurement section 24 may instead be so configured that it multiplies the signal level of the second detection signal V₂ by a correction coefficient (sensitivity of first light receiving device/sensitivity of second light receiving device, for example) to allow the signal level of the second detection signal V₂ to match with the signal level of the first detection signal V₁. The spectroscopic measurement section 24 may still instead be so configured that it divides each of the detection signals by the sensitivity of the corresponding light receiving device to calculate signal levels comparable between the light receiving devices.

### Advantageous Effects of First Embodiment

In the present embodiment, the light receiving devices 11 and 13 having different sensitivities are provided and allowed to receive the divided light fluxes from the light dividing element 6 to acquire the first detection signal V₁ from the low-sensitivity first light receiving device 11 and the second detection signal V₂ from the high-sensitivity second light receiving device 13.

In the configuration described above, even when the amounts of the divided light fluxes vary depending on a measurement wavelength or an object under measurement, the divided light having a larger amount of light can be detected with the first light receiving device 11 and the divided light having a smaller amount of light can be detected with the second light receiving device 13. Therefore, at least one light receiving device that can be exposed to light under measurement within the adequate exposure range of the light receiving device in correspondence with the width of variation in the amount of light under measurement can be readily provided.

As a result, to widen the measurable light amount width of the light under measurement, it is not necessary to use a wide-dynamic-range, high-sensitivity light receiving device. Further, for example, to set an exposure period that achieves light exposure within an optimum exposure range in relation to the dynamic range of a light receiving device at each measurement wavelength, it is not necessary to perform preliminary exposure. The measurable light amount width of light under measurement can thus be readily widened. Further, since preliminary exposure is not required, the measurement period can be shortened.

In the present embodiment, the selection section 23 selects one of the first detection signal V₁ and the second detection signal V₂ at pixels corresponding to each other at each measurement wavelength, specifically, the detection signal so detected that it has a signal level corresponding to light exposure within the adequate exposure range of the selected light receiving device. The adequate exposure ranges corresponding to the light receiving devices 11 and 13 having different sensitivities can therefore be measureable exposure ranges, whereby the measurable light amount width (dynamic range) of the light under measurement can be widened. Further, not only can the dynamic range be widened but also a detection signal having a signal level corresponding to the adequate exposure range can be a result of spectroscopic measurement, whereby the spectroscopic measurement can be performed with higher precision.

In the present embodiment, in particular, the selection section 23 selects one of the first detection signal V₁ and the second detection signal V₂ that has a signal level that is the highest but lower than the maximum signal level. As a result, a detection signal that corresponds to maximum light exposure but is not higher than saturated light exposure can be selected for each of a plurality of wavelengths. As a result, higher-precision spectroscopic measurement can be performed with the amount of noise reduced.

Further, to obtain light exposure that does not exceed saturated light exposure but falls within an adequate exposure range at each of a plurality of wavelengths, it is not necessary to perform preliminary exposure that allows setting of an adequate exposure period at each wavelength whenever an object under measurement is changed. The measurement period can therefore be shortened.

Moreover, since preliminary exposure is not required, the measurement period can further be shortened in a case where the measurement is continuously performed with an object under measurement is repeatedly changed.

In the present embodiment, the light receiving devices 11 and 13, each of which has a plurality of pixels, output detection signals on a pixel basis. The selection section 23 selects one of the first detection signal V₁ acquired with the low-sensitivity first light receiving device 11 and the second detection signal V₂ acquired with the high-sensitivity second light receiving device 13, specifically, one of the detection signals V₁ and V₂ that has a signal level lower than the maximum signal level.

In a case where a light receiving device having a plurality of pixels receives light, a high signal level is obtained at a pixel corresponding to a portion where the reflectance at a measurement wavelength is high, whereas a low signal level is obtained at a pixel corresponding to a low reflectance portion. In this case, for example, when preliminary exposure is performed to set an exposure period corresponding to each wavelength, and the exposure period is so set that light exposure does not exceed saturated light exposure in correspondence with the high reflectance portion, sufficient light exposure cannot undesirably be acquired in some cases at a pixel corresponding to the low reflectance portion. In this case, at the pixel corresponding to the low reflectance portion, the difference between the acquired light exposure and noise components is small, resulting in a high content of noise components in a detection signal and high-precision spectroscopic measurement cannot be performed.

On the other hand, when the exposure period is set to be long enough to allow the amount of light to which the low reflectance portion is exposed to fall within an adequate exposure range, a pixel corresponding to the high reflectance portion can be overexposed, resulting in spectroscopic measurement with insufficient precision.

In contrast, since a detection signal is selected on a pixel basis as described above in the present embodiment, measurement with the amount of noise components reduced (with SN ratio increased) can be performed even at a pixel corresponding to the low reflectance portion. Further, since a detection signal having a signal level lower than the maximum signal level is selected on a pixel basis as described above, it is possible to suppress generation of pixels at which an accurate amount of received light cannot be acquired due to overexposure.

In the configuration described above, for example, in a case where a user desires to perform spectroscopic measurement (color measurement) on one predetermined pixel specified by the user in a captured image, the spectroscopic measurement can be performed with high precision on a pixel basis.

In the present embodiment, when the low-sensitivity first light receiving device 11 acquires the amount of light to which the white reference object, which is a reference object having high reflectance in the visible region, is exposed at each wavelength, the exposure period T_{c} is so set that detection signals corresponding the wavelengths have signal levels lower than the maximum signal level Vₘₐₓ₁.

As a result, as the first detection signal V₁ from the low-sensitivity first light receiving device 11, a detection signal having a signal level lower than the maximum signal level Vₘₐₓ₁ corresponding to the saturated light exposure can be acquired at each of the wavelengths. Therefore, even when light under measurement contains a wavelength region containing wavelengths at which reflectance is high, at least one detection signal corresponding to light exposure that does not cause overexposure at each wavelength within the wavelength range under measurement can be acquired without preliminary light exposure for setting an exposure period.

Further, in the present embodiment, when the high-sensitivity second light receiving device 13 acquires the amount of light to which the black reference object, which is a reference object having low reflectance in the visible region, is exposed at each wavelength, the exposure period T_{c} is so set that detection signals corresponding the wavelengths have signal levels higher than or equal to the lower limit signal level Vₘᵢₙ₂.

As a result, as the second detection signal V₂ from the high-sensitivity second light receiving device 13, at least one detection signal having a signal level that is not lower than the lower limit signal level corresponding to the lower limit of the adequate exposure range can be acquired at each of the wavelengths.

Further, since the first detection signal V₁ and the second detection signal V₂ corresponding to the exposure periods T_{c} described above can be acquired, at least one detection signal corresponding to the adequate exposure range can be acquired. As a result, even when an object under measurement has high reflectance or low reflectance is continuously measured, at least one of the first detection signal V₁ and the second detection signal V₂ can be acquired as a detection signal corresponding to the adequate exposure range. Light exposure within the adequate exposure range can therefore be acquired without performing preliminary exposure at each wavelength to set an exposure period in advance whenever an object under measurement is changed, whereby the measurement period can be shortened with the measurement precision maintained.

In the present embodiment, the wavelength tunable interference filter 5, which is a Fabry-Perot filter, is used as the spectroscopic device that extracts light of a predetermined wavelength from light reflected off an object X under measurement and allows the extracted light to exit.

Using the wavelength tunable interference filter 5 as the spectroscopic device allows measurement to be performed at wavelengths under measurement set apart by very narrow intervals, such as 10 nm. The measurement can therefore be performed at a large number of measurement wavelengths (several tens of measurement wavelengths, for example) within a wavelength range under measurement as compared with a case where the controllable interval between wavelengths under measurement is large. In the latter case, performing preliminary exposure described above on an object under measurement at a plurality of measurement wavelengths or performing preliminary exposure whenever an object under measurement is changed increases the period spent for the preliminary exposure as compared with a case where the measurement is performed at about several wavelengths. Employing the wavelength tunable interference filter 5 in a configuration that does not require preliminary exposure as in the present embodiment can therefore further shorten the measurement period.

### Second Embodiment

A second embodiment according to the invention will be described below with reference to the drawings.

A spectroscopic measurement apparatus in the second embodiment differs from the spectroscopic measurement apparatus in the first embodiment in that two light receiving devices having different resolutions are provided as the light receiving devices. The other points are basically the same as those in the first embodiment, and no detailed description thereof will therefore be made and the following description will be primarily made of the different point.

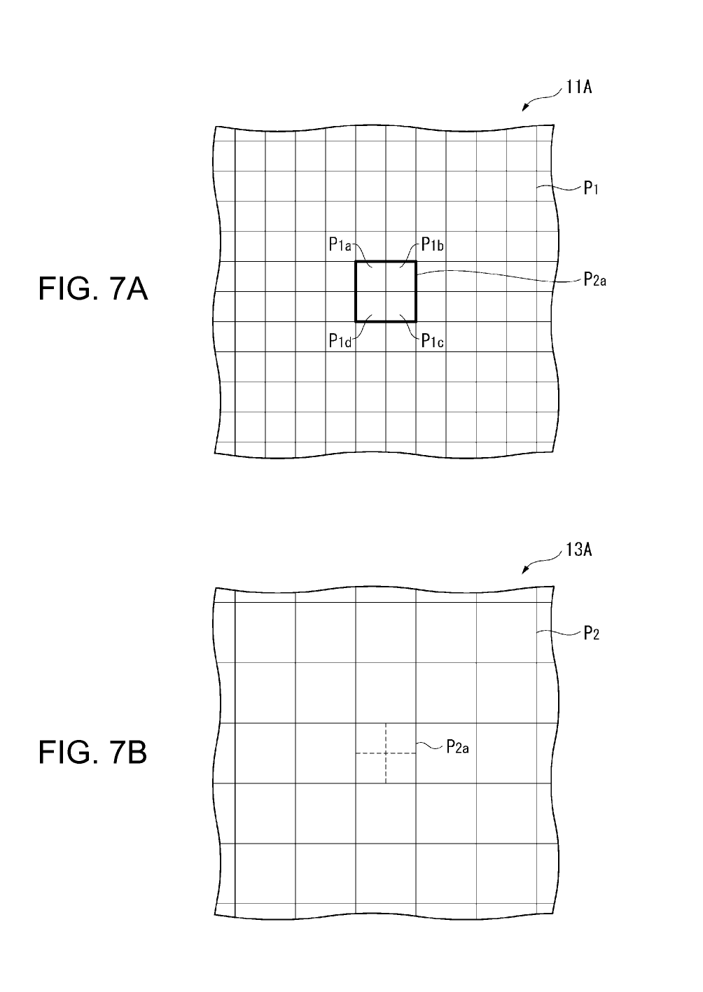

FIGS. 7A and 7B diagrammatically show the light receiving surfaces of light receiving devices 11A and 13A in the second embodiment according to the invention. FIG. 7A diagrammatically shows the first light receiving device 11A, and FIG. 7B diagrammatically shows the second light receiving device 13A.

The light receiving surface of the first light receiving device 11A is formed of a plurality of pixels P₁, as shown in FIG. 7A. Similarly, the light receiving surface of the second light receiving device 13A is formed of a plurality of pixels P₂, as shown in FIG. 7B. Four pixels P₁ₐ, P_{1b}, P_{1c}, and P_{1d} in the first light receiving device 11A, which are surrounded by the thick line in FIG. 7A, correspond to a pixel Pₑₐ in the second light receiving device 13A shown in FIG. 7B. As shown in FIGS. 7A and 7B, each of the pixels P₂, which form the second light receiving device 13A, has an area larger than the area of each of the pixels P₁, which form the first light receiving device 11A (four times larger as an example in FIGS. 7A and 7B). That is, the first light receiving device 11A has resolution higher than that of the second light receiving device 13A. In the following description, the light receiving devices 11A and 13A are also called a high-resolution first light receiving device 11A and a low-resolution second light receiving device 13A, respectively.

It is assumed in the present embodiment that the light receiving devices 11A and 13A have the same light reception sensitivity per unit area. In this case, the sensitivity of each of the pixels P₁ and P₂ in the light receiving devices 11A and 13A is proportional to the area of the pixel, and the pixels P₂, each of which has a larger area, have high sensitivity than the pixels P₁, each of which has a smaller area. That is, when the sensitivity per pixel is compared between the light receiving devices 11A and 13A, the high-resolution first light receiving device 11A has lower sensitivity, and the low-resolution second light receiving device 13A has higher sensitivity.

### Spectroscopic Measurement Process

A spectroscopic measurement process carried out by the spectroscopic measurement apparatus in the second embodiment, which includes the thus configured first light receiving device 11A and second light receiving device 13A, is basically the same as the spectroscopic measurement process carried out by the spectroscopic measurement apparatus 1 in the first embodiment except the acquired light reception data selection process.

In the light reception data selection process instep S5 in the spectroscopic measurement process shown in FIG. 5 and carried out by the spectroscopic measurement apparatus 1 in the first embodiment, the spectroscopic measurement apparatus in the second embodiment selects one of the first light reception data and the second light reception data as a measurement result at each pixel at each wavelength, specifically, light reception data associated with the detection signal having a signal level within the saturated exposure range of the corresponding light receiving device (when both the data apply, either of them is selected), as the spectroscopic measurement apparatus 1 in the first embodiment does.

In this process, in the present embodiment, the selection section 23 selects the first light reception data corresponding to the high-resolution, low-sensitivity first light receiving device 11A when the first detection signal from the first light receiving device 11A has a signal level higher than or equal to the lower limit signal level Vₘᵢₙ₁ of the adequate exposure range, whereas selecting the second light reception data corresponding to the second light receiving device 13A when the first detection signal has a signal level lower than the lower limit signal level Vₘᵢₙ₁ at each wavelength.

In other words, in a spectroscopic image acquired with the high-resolution first light receiving device 11A, a pixel showing a lower amount of light than the lower limit signal level (insufficient light amount pixel) is detected. The amount of light at a pixel corresponding to the insufficient light amount pixel in the spectroscopic image acquired with the second light receiving device 13A is then detected, and the amount of light at the insufficient light amount pixel is replaced with a corrected amount of light obtained by correcting the detected amount of light in accordance with the sensitivity ratio between the two light receiving devices.

In the present embodiment, each of the light receiving devices 11A and 13A has a predetermined light amount width as a measurable light amount width of light under measurement in accordance with an adequate exposure range of the light receiving device, and the predetermined light amount widths of the light receiving devices 11A and 13A at least partially overlap with each other, as in the embodiment described above. The amount of light under measurement within a single continuous predetermined light amount width can therefore be appropriately detected.

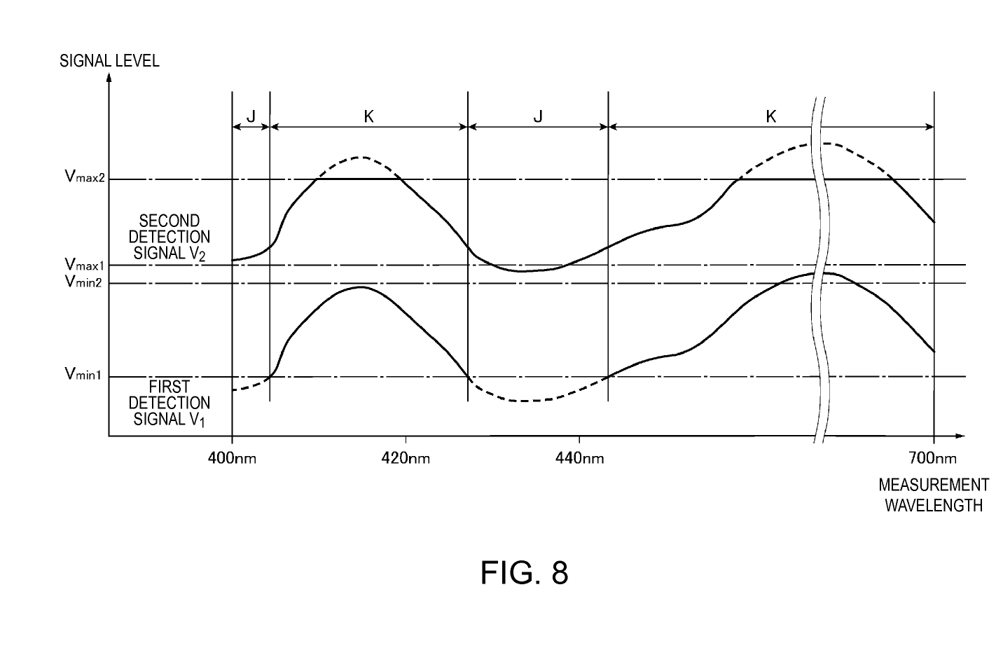

FIG. 8 shows graphs illustrating an example of the relationship between the measurement wavelength and the signal level of each of the detection signals at one predetermined pixel corresponding to the same measurement position among the plurality of pixels that form the light receiving devices 11A and 13A. A first detection signal V₁ shown in FIG. 8 is provided from the high-resolution, low-sensitivity first light receiving device 11A and has a signal level lower than the signal level of a second detection signal V₂ from the low-resolution, high-sensitivity second light receiving device 13A. Further, the first detection signal V₁, which does not exceed the saturated light exposure and corresponds to the exposure period T_{c}, has a signal level lower than the maximum signal level Vₘₐₓ₁ at each wavelength within a wavelength range under measurement, as described above. The second detection signal V₂, which is not lower than the lower limit of an optimum exposure range and corresponds to the light exposure period T_{c}, has a signal level higher than or equal to the lower limit signal level Vₘₐₓ₂ as described above.

When the first detection signal V₁ from the high-resolution first light receiving device 11A is higher than or equal to the lower limit signal level Vₘᵢₙ₁, that is, in wavelength ranges labeled with segments K shown in FIG. 8, the first light reception data corresponding to the first detection signal V₁, which has been detected with the high-resolution first light receiving device 11A, is selected.

When the first detection signal V₁ is lower than the lower limit signal level Vₘᵢₙ₁, that is, in wavelength ranges labeled with segments J shown in FIG. 8, the pixel under measurement is determined to be an insufficient light amount pixel, and the second light reception data corresponding to the second detection signal V₂, which has been detected with the low-resolution, high-sensitivity second light receiving device 13A, is selected.

In this process, the first light reception data at all pixels P₁ in the first light receiving device 11A that are present in the region of a pixel P₂ corresponding to the selected second light reception data are replaced with the second light reception data. For example, in FIG. 7A, when the detection signal at the pixel P₁ₐ in the high-resolution first light receiving device 11A is lower than the lower limit signal level Vₘᵢₙ₁, and even when the detection signals at the pixels P_{1b}, P_{1c}, and P_{1d} are higher than or equal to the lower limit signal level Vₘᵢₙ₁ the second light reception data at the pixel P₂ₐ corresponding to the low-resolution second light receiving device 13A is selected as the light reception data also at the pixels P_{1b}, P_{1c}, and P_{1d}.

The four pixels P₁ₐ, P_{1b}, P_{1c}, and P_{1d} in the first light receiving device 11A may be considered as a set of pixels, and the process described above may be changed in accordance with the number of insufficient light amount pixels among the four pixels. For example, when a predetermined number (three, for example) of pixels out of the four pixels in the first light receiving device 11A are insufficient light amount pixels, a corrected amount of light for one of the insufficient light amount pixels in the first light receiving device 11A is calculated based on the amount of light at the pixel P₂ₐ in the second light receiving device 13A, and the amount of light at each of the insufficient light amount pixels is replaced with the corrected amount of light. On the other hand, when the number of insufficient light amount pixels is smaller than a predetermined number (two, for example), the average of the amounts of light at pixels in the first light receiving device 11A where light exposure within the adequate exposure range of the first light receiving device 11A is provided is calculated, and the light amount average is used as the amount of light at each of the insufficient light amount pixels.

As described above, the selection section 23 selects light reception data at each pixel at each wavelength to acquire a spectroscopic measurement result at the wavelengths.

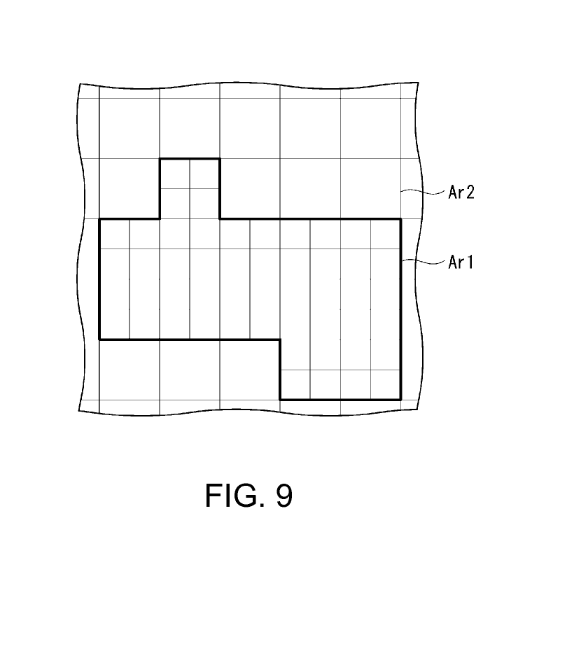

FIG. 9 diagrammatically shows an example of a spectroscopic image as the spectroscopic measurement result.

A region Ar1 surrounded by the thick line in FIG. 9 is a region where the first light reception data from the high-resolution first light receiving device 11A is selected, and a region Ar2, which is the other region, is a region where the second light reception data from the low-resolution second light receiving device 13A is selected. As described above, in the region Ar1, where detection signals having signal levels corresponding to the adequate exposure range of the first light receiving device 11A are detected and hence the first light reception data can be selected, the light reception data from the high-resolution first light receiving device 11A is selected.

### Advantageous Effect of Second Embodiment

In the present embodiment, the light receiving devices 11A and 13A have sensitivities per pixel different from each other. As a result, detection signals according to the sensitivities of the light receiving devices 11A and 13A are simultaneously acquired from light under measurement from the same object under measurement. The selection section 23 then selects one of the detection signals, specifically, the detection signal that not only has a signal level corresponding to the adequate exposure range of the light receiving device that has outputted the selected detection signal but also is provided from the highest-resolution light receiving device as the detection signal from the pixels corresponding to each other.

As a result, a detection signal that is provided from the higher-resolution light receiving device and falls within the adequate exposure range thereof and can be selected as a spectroscopic measurement result, whereby a higher-resolution spectroscopic measurement result can be readily acquired without any change in the exposure period in accordance with the amount of light under measurement and preliminary exposure for setting the exposure period. Further, since preliminary exposure is not required as described above, the measurement period spent to acquire a high-resolution spectroscopic measurement result can be shortened.

### Third Embodiment

A third embodiment according to the invention will be described below with reference to the drawings.

A spectroscopic measurement apparatus in the third embodiment differs from the spectroscopic measurement apparatus in the first embodiment in that it includes a light source that emits light with which an object under measurement is illuminated, acquires a light source characteristic representing an output value from the light source at each wavelength, and selects a detection signal based on the light source characteristic. The other points are basically the same as those in the first embodiment, and no detailed description thereof will therefore be made and the following description will be primarily made of the different point.

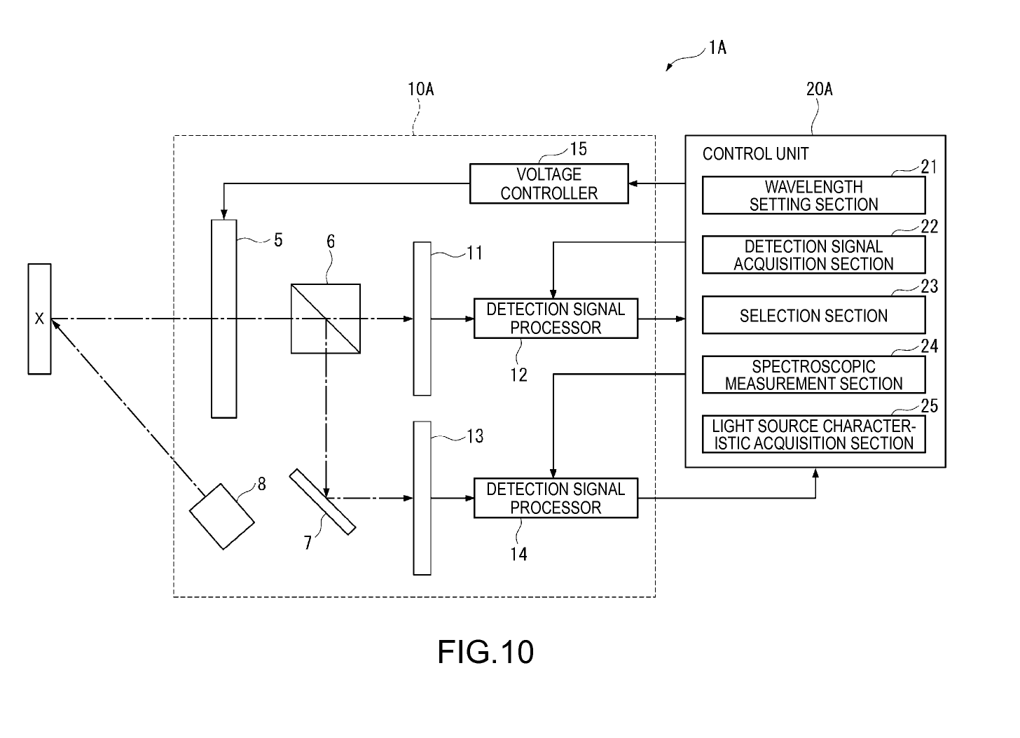

FIG. 10 is a block diagram showing a spectroscopic measurement apparatus 1A in the third embodiment according to the invention.

The spectroscopic measurement apparatus 1A includes an optical module 10A and a control unit 20A, as shown in FIG. 10.

The optical module 10A includes a light source 8, which emits light toward an object X under measurement. The optical module 10A is configured in the same manner in terms of the other points as the spectroscopic measurement apparatus 1 in the first embodiment.

The control unit 20A includes a light source characteristic acquisition section 25. The light source characteristic acquisition section 25 acquires, as a characteristic of the light amount value of illumination light emitted from the light source 8, a light source characteristic representing an output value (light amount value) of the illumination light at each wavelength. The light source characteristic acquisition section 25 may instead acquire the light source characteristic by reading a light source characteristic measured in advance based on the light source 8 and stored in a memory. Still instead, the light source characteristic may be acquired from a result of spectroscopic measurement performed on reflected light produced when a white reference or any other object is actually irradiated with the light from the light source 8.

In the present embodiment, the selection section 23 in the control unit 20A selects a detection signal based on the light source characteristic of the light source 8 in such a way that the detection signal selected from detection signals corresponding to each of the pixels in the light receiving devices 11 and 13 has a signal level corresponding to the adequate exposure range of the selected one of the light receiving devices 11 and 13.

For example, the selection section 23 selects a detection signal from the low-sensitivity first light receiving device 11 when the output value of the illumination light at a wavelength under measurement is greater than or equal to a predetermined threshold whereas selecting a detection signal from the high-sensitivity second light receiving device 13 when the output value is smaller than the threshold.

### Advantageous Effect of Third Embodiment

The spectroscopic measurement apparatus 1A in the present embodiment can predict the amount of light having exited out of the wavelength tunable interference filter 5 and the upper limit of the amount of each of the divided light fluxes at each wavelength based on the light source characteristic of the light source 8. That is, the magnitude of the upper limit of the amount of each of the divided light fluxes at each wavelength corresponds to the magnitude of the output value from the light source 8. The spectroscopic measurement apparatus 1A therefore selects, for example, the first detection signal from the low-sensitivity first light receiving device 11 when the light source 8 emits light having a large output value, whereas selecting the second detection signal from the high-sensitivity second light receiving device 13 when the output value is small. An appropriate detection signal can thus be selected in accordance with the characteristic of the light source 8.

In the present embodiment, a light source that emits light also having a wavelength range other than the visible light range (infrared region, ultraviolet region, for example) maybe combined with a light receiving device having high light reception sensitivity at wavelengths in the visible light range and a light receiving device having high sensitivity at wavelengths in the wavelength range described above other than the visible light range. For example, the light source 8 may be configured to be capable of emitting light ranging from light in the visible light range to light in the infrared wavelength range, and the first light receiving device 11 and the second light receiving device 13 may be so configured that the first light receiving device 11 is more sensitive to the light in the infrared wavelength range but less sensitive to the light in the visible light range and the second light receiving device 13 is more sensitive to the light in the visible light range but less sensitive to the light in the infrared wavelength range. In this case, when the wavelength under measurement is an infrared wavelength, and the light source 8 emits light having a large output value at the infrared wavelength, the selection section 23 selects a detection signal from the second light receiving device 13, whereas selecting a detection signal from the first light receiving device 11 when the light source 8 emits light having a small output value at the infrared wavelength. Similarly, when the wavelength under measurement is a visible wavelength, and the light source 8 emits light having a large output value at the visible wavelength, the selection section 23 selects a detection signal from the first light receiving device 11, whereas selecting a detection signal from the second light receiving device 13 when the light source 8 emits light having a small output value at the visible wavelength.

The configuration described above allows selection of a detection signal from a light receiving device having optimum light reception sensitivity in accordance with the wavelength range of the light emitted from the light source (light source characteristic).

### Variations of Embodiments

The invention is not limited to the embodiments described above, and configurations obtained, for example, by changing, improving, and appropriately combining the embodiments to the extent that the advantage of the invention is achieved fall within the scope of the invention.

For example, in each of the embodiments described above, the invention is applied to the spectroscopic measurement apparatus having the configuration in which an optical spectrum is acquired based on a measurement result by way of example, but the invention is not necessarily applied to a spectroscopic measurement apparatus and can be applied to an analyzer that performs component analysis on an object under measurement or otherwise analyzes the object under measurement, a spectroscopic camera that acquires a spectroscopic image, and other apparatus. To apply the invention to a spectroscopic camera, the spectroscopic camera may be so configured that a detection signal is selected at each pixel at each wavelength and a spectroscopic image at the wavelengths is acquired based on the selected detection signals at the pixels. Further, a colorimetry process may be carried out based on an acquired spectroscopic image. In the configurations described above, the dynamic range of light under measurement from an object under measurement can be widened as in the embodiments described above.

In each of the embodiments described above, the visible region is presented as the wavelength range to be measured by way of example, but the invention is not necessarily configured in this way and the wavelength range to be measured may be the infrared region or any other arbitrary wavelength range.

In each of the embodiments described above, the white reference plate, which reflects light that belongs to the visible region at high reflectance, and the black reference plate, which reflects the light at low reflectance, are used to set the exposure periods, but when the wavelength range under measurement contains a wavelength range other than the visible region, a high reflectance reference that reflects light that belongs to the wavelength range under measurement at high reflectance and a low reflectance reference that reflects the light at low reflectance may be used.

In each of the embodiments described above, the two light receiving devices having different sensitivities are used to acquire detection signals according to the sensitivities, but the invention is not necessarily configured in this way.

For example, three or more light receiving devices having sensitivities different from each other may be used. Using light receiving devices corresponding to a greater number of light reception sensitivities allows a wider measureable optical intensity dynamic range. As a result, high-precision spectroscopic measurement can be more reliably performed on an object under measurement having high reflectance or low reflectance.

Further, in this case, among detection signals from a plurality of light receiving devices, any of the detection signals may be so selected that the detection signal has a signal level corresponding to the adequate exposure range of the light receiving device that outputs the selected detection signal. Further, in the selection of a detection signal, a detection signal having the greatest signal level may be selected, or a detection signal from a light receiving device having the highest resolution may be selected.

In each of the embodiments described above, the light dividing element divides light under measurement into divided light fluxes having substantially the same amounts of light, but the invention is not necessarily configured in this way and the light under measurement may be divided into divided light fluxes having different amounts of light. In this configuration, the divided light fluxes having different amounts of light are incident on a plurality of light receiving devices in some cases.

Even in such cases, the same processes as those in each of the embodiments described above can be carried out on detection signals from the light receiving devices by setting the sensitivities of the light receiving devices in accordance with the light amount ratio among the divided light fluxes in advance.

In the second embodiment described above, the light receiving devices have the same sensitivity per unit area but different areas per pixel so that a higher-resolution light receiving device has lower sensitivity by way of example, but the invention is not necessarily configured in this way. For example, the light receiving devices may have different sensitivities per unit area. That is, a configuration in which a high-sensitivity, high-resolution light receiving device and a lower-sensitivity, low-resolution light receiving device are provided may be employed. Also in this case, the dynamic range can be widened even when the amount of light under measurement varies.

In the second embodiment described above, in a case where the first detection signal from the high-resolution, low-sensitivity first light receiving device 11A has a signal level lower than the lower limit signal level Vₘᵢₙ₁ of the adequate exposure range, the first detection signal is replaced with the second detection signal from the low-resolution, high-sensitivity second light receiving device 13A at the pixels corresponding to each other, but the invention is not necessarily configured in this way. For example, in a case where the second detection signal from the low-resolution, high-sensitivity second light receiving device 13A reaches the maximum signal level Vₘₐₓ₂ the second detection signal may be replaced with the first detection signal from the high-resolution, low-sensitivity first light receiving device 11A.

The embodiments described above may be combined with each other as appropriate. For example, the first embodiment and the second embodiment may be so combined with each other as appropriate that a plurality of sets of light receiving devices having the same resolution but different sensitivities per pixel are employed in correspondence with a plurality of different resolutions. In this case, a detection signal can be selected from detection signals according to the plurality of resolutions in each adequate exposure range. In this process, for example, the resolutions to be selected may be changed in accordance with necessary measurement precision.

Further, for example, the first embodiment and the second embodiment may be combined with the third embodiment, in which a light source is provided.

In each of the embodiments described above, the wavelength tunable interference filter 5 may, for example, be accommodated in a package, and the package may be incorporated in the optical module 10. In this case, the package may be sealed and maintained under vacuum so that the electrostatic actuator 56 in the wavelength tunable interference filter 5 shows improved drive response to voltage application.

In each of the embodiments described above, the wavelength tunable interference filter 5 includes the electrostatic actuator 56, which changes the dimension of the gap between the reflection films 54 and 55 through voltage application, but the wavelength tunable interference filter 5 is not necessarily configured in this way.

For example, the wavelength tunable interference filter 5 may use an induction actuator having a first induction coil provided in place of the fixed electrode 561 and a second induction coil or a permanent magnet provided in place of the movable electrode 562.

Further, the electrostatic actuator 56 may be replaced with a piezoelectric actuator. In this case, for example, a lower electrode layer, a piezoelectric film, and an upper electrode layer are layered on each other and disposed at the holding portion 522, and a voltage applied between the lower electrode layer and the upper electrode layer can be changed as an input value to expand or contract the piezoelectric film so as to bend the holding portion 522.

In each of the embodiments described above, the wavelength tunable interference filter 5 is configured as a Fabry-Perot etalon and includes the fixed substrate 51 and the movable substrate 52 so bonded to each other that they face each other with the fixed reflection film 54 provided on the fixed substrate 51 and the movable reflection film 55 provided on the movable substrate 52, but the configuration of the wavelength tunable interference filter 5 is not limited thereto.

For example, the wavelength tunable interference filter 5 may instead be so configured that the fixed substrate 51 and the movable substrate 52 are not bonded to each other but a gap changer that changes the inter-reflection-film gap, such as a piezoelectric device, is provided between the substrates.

Further, the wavelength tunable interference filter 5 is not necessarily formed of two substrates. For example, a wavelength tunable interference filter having the following configuration may be used: Two reflection films are layered on a single substrate with a sacrifice layer between the reflection films; and the sacrifice layer is etched away or otherwise removed to form a gap.

Moreover, as the spectroscopic device, an AOTF (acousto optic tunable filter), an LCTF (liquid crystal tunable filter), or any other tunable filter may be used. From a viewpoint of size reduction of the apparatus, however, it is preferable to use a Fabry-Perot filter as in each of the embodiments described above.

The entire disclosure of Japanese Patent Application No. 2013-238593 filed on Nov. 19, 2013 is expressly incorporated by reference herein.

What is claimed is:

1. A spectroscopic measurement apparatus comprising:
a spectroscopic device that selects light of a predetermined wavelength from incident light, allows the selected light to exit, and is capable of changing the wavelength of the light that is allowed to exit;
a light dividing element that divides the exiting light having exited out of the spectroscopic device into a plurality of light fluxes; and
a plurality of light receiving devices that are provided in correspondence with the plurality of divided light fluxes divided by the light dividing element and have sensitivities different from each other.

2. The spectroscopic measurement apparatus according to claim 1,
wherein each of the light receiving devices outputs a detection signal according to the amount of light to which the light receiving device is exposed, and
the spectroscopic measurement apparatus further comprises:
a detection signal acquisition section that acquires the detection signals from the plurality of light receiving devices; and
a selection section that selects, from the plurality of detection signals acquired with the plurality of light receiving devices, a detection signal so outputted that the detection signal has a signal level corresponding to the range of light exposure for adequate exposure associated with the light receiving device having outputted the selected detection signal.

3. The spectroscopic measurement apparatus according to claim 2,
wherein each of the light receiving devices has a plurality of pixels that receive light and outputs the detection signal on a pixel basis, and
the selection section selects, from the plurality of detection signals outputted from pixels corresponding to each other in the plurality of light receiving devices, one of the detection signals corresponding to the pixels.

4. The spectroscopic measurement apparatus according to claim 2,
wherein the selection section selects, from the plurality of detection signals at the predetermined wavelength, a detection signal that not only corresponds to the range of light exposure for adequate exposure associated with the light receiving device having outputted the selected detection signal but also is so outputted that the detection signal has the greatest signal level.

5. The spectroscopic measurement apparatus according to claim 3,
wherein the plurality of light receiving devices have resolutions that differ from each other and decrease as sensitivities of the light receiving devices increase, and
the selection section selects, from the plurality of detection signals acquired in the same measurement position at the predetermined wavelength, a detection signal that corresponds to the range of light exposure for adequate exposure associated with the light receiving device having outputted the selected detection signal and is outputted from the light receiving device having the highest resolution.

6. The spectroscopic measurement apparatus according to claim 2, further comprising:
a light source; and
a light source characteristic acquisition section that acquires an output value from the light source at each wavelength,
wherein the selection section selects a detection signal in accordance with the output value from the light source at the wavelength of the light that the spectroscopic device allows to exit.

7. The spectroscopic measurement apparatus according to claim 1,
wherein the spectroscopic device is a Fabry-Perot filter.

8. A spectroscopic measurement method in a spectroscopic measurement apparatus including a spectroscopic device that selects light of a predetermined wavelength from incident light, allows the selected light to exit, and is capable of changing the wavelength of the light that is allowed to exit, a light dividing element that divides the exiting light having exited out of the spectroscopic device into a plurality of light fluxes, and a plurality of light receiving devices that are provided in correspondence with the plurality of divided light fluxes divided by the light dividing element and have sensitivities different from each other, the method comprising:
allowing the spectroscopic measurement apparatus to
sequentially switch the wavelength by using the spectroscopic device and acquire detection signals from the plurality of light receiving devices at the wavelength, and
select, from the plurality of detection signals acquired with the plurality of light receiving devices, a detection signal so outputted that the detection signal has a signal level corresponding to the range of light exposure for adequate exposure associated with the light receiving device having outputted the selected detection signal.
